(19) United States
(12) Patent Application Publication
(10) Pub. No.: US 2025/0374319 A1
(43) Pub. Date: Dec. 4, 2025

(54) WIRELESS COMMUNICATION SYSTEM AND WIRELESS CHANNEL ALLOCATION MANAGEMENT

(71) Applicant: Charter Communications Operating, LLC, St. Louis, MO (US)

(72) Inventors: Prabhath Narayanan Nair, Parker, CO (US); Vijay K. Mechineni, Parker, CO (US)

(21) Appl. No.: 18/731,647

(22) Filed: Jun. 3, 2024

(51) Int. Cl. H04W 72/566; H04L 5/00

(52) U.S. Cl. CPC H04W 72/566; H04L 5/0053

(57) ABSTRACT

A system as discussed herein includes communication management hardware. The communication management hardware: uses a first wireless channel to support wireless connectivity between a first wireless base station and a first mobile communication device; receives a first notification indicating a second wireless channel allocated for use by the first wireless base station, the second wireless channel being a substitute for the first wireless channel; and in response to receiving first notification, transmitting a first message from the first wireless base station, the first message indicating allocation of the second wireless channel to the first wireless base station.

### BACKGROUND

Conventional wireless networks typically include one or more wireless base stations or wireless access points to provide mobile communication devices (a.k.a., user equipment) access to a remote network such as the Internet or other target communication devices and remote locations. In certain instances, the wireless networks include many different types of networks and/or components that must collectively work together to provide wireless services.

One conventional type of wireless network is a 5G wireless network. A 5G wireless network typically includes at least one so-called 5G radio access network (RANs) and corresponding 5G core network. A conventional 5G wireless base station may be connected to a 5G core network via an IP network commonly referred to as a backhaul.

One way to implement a 5G wireless network is use of allocated wireless channels in a CBRS (Citizen Band Radio System) communication system. In such a system, an incumbent entity (such as a communication device operated by the government) has higher priority rights to use wireless channels than a so-called PAL (Priority Access License) user and a GAA (General Authorized Access) user. The PAL users have higher priority access rights than GAA users.

### BRIEF DESCRIPTION

Techniques as discussed herein provide improved use of wireless channels in a wireless network environment.

For example, a communication management resource such as associated with a first wireless base station as discussed herein utilizes a first wireless channel to support wireless connectivity between the first wireless base station any number of communication devices such as including a first mobile communication device (a.k.a., user equipment). Assume that the communication management resource receives a first notification indicating a second wireless channel allocated for use by the first wireless base station as a substitute to the first wireless channel. The first notification may be received from a wireless channel allocation management resource that allocates use of different wireless channels in the network environment. Assume in this example, that the second wireless channel allocated to the first wireless base station is a substitute for the first wireless channel. In response to receiving the first notification, the communication management resource associated with the first wireless base station transmits a first message from the first wireless base station to a second wireless base station. The first message indicates allocation of the second wireless channel to the first wireless base station. Accordingly, the second wireless base station is aware of the newly allocated wireless channel used by the first wireless base station.

In a similar manner, the first wireless base station can be configured to communicate with any number of wireless base stations in the network environment to keep them updated as to the current wireless channel allocated for use by the first wireless base station.

As further discussed herein, the communication management resource can be configured to receive the first notification of the substitute wireless channel for any reason. In one example, the communication management resource receives the first notification in response to detected use of the first wireless channel by an incumbent entity having higher priority rights to use the first wireless channel than the first wireless base station.

In accordance with still further examples as discussed herein, transmission of the first message indicating the newly assigned wireless channel from the first wireless base station may include the first wireless base station transmitting the first message from the first wireless base station to a second wireless base station. The second wireless base station may be within wireless range of the first mobile communication device. In such an instance, the first wireless base station and the second wireless base station are both able to provide a corresponding communication device wireless access to a remote network.

Still further examples as discussed herein include the first wireless base station transmitting the first message in response to detecting a condition in which the second wireless base station supports receiving handoffs from the first wireless base station. In other words, the first wireless base station or other suitable entity can be configured to determine that the second wireless base station resides nearby the first wireless base station and that they both have the ability to support wireless connectivity in a same region of wireless coverage. In such an instance, based on the notification of assignment wireless channels as discussed herein, each wireless base station has knowledge of the wireless channels supported by the other one or more base stations, facilitating more efficient handoffs of communication devices amongst the wireless base stations.

In further examples as discussed herein, the second wireless base station as discussed herein may be assigned use of any wireless channel such as the first wireless channel, the second wireless channel, etc., to support wireless connectivity with mobile communication devices.

In yet another example as discussed herein, subsequent to receiving the first notification, the first wireless base station receives a second notification indicating reassignment of the first wireless channel allocated for use by the first wireless base station instead of the second wireless channel. In other words, the incumbent entity may discontinue use of the first wireless channel. The first wireless base station may be assigned use of the first wireless channel as a substitute to the second wireless channel because the first wireless channel is now free to be used by the first wireless base station. In response to receiving the second notification, the communication management resource transmits a second message from the first wireless base station. The second message can be configured to indicate allocation of the first wireless channel to the first wireless base station. In one example, the first wireless base station and corresponding communication management resource receives the second notification in response to discontinued use of the first wireless channel by an entity having higher priority rights to use the first wireless channel than the first wireless base station.

Yet further, the communication management resource associated with the first wireless base station as discussed herein can be configured to receive a second message from a second wireless base station. Assume that the second message indicates allocation of the second wireless channel to the second wireless base station. Accordingly, the first wireless base station is aware of assignment of the second wireless channel to the second wireless base station. In response to receiving the second message, the communication management resource associated with the first wireless base station updates neighbor information associated with the first wireless base station. The update to the neighbor information associated with the first wireless base station indicates that the second wireless base station supports the second wireless channel for handoffs between the first wireless base station and the second wireless base station.

In a further example, in response to receiving notification that the first wireless base station supports the second wireless channel, the second wireless base station and corresponding communication management function associated with the second wireless station updates its neighbor information indicating that the first wireless base station supports the second wireless channel instead of the first wireless channel for handoffs between the first wireless base station and the second wireless base station.

Techniques as discussed herein are useful over conventional techniques. For example, one or more implementation of a communication management resource and corresponding operations as discussed herein provide better use of available wireless channels in a network environment.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium or any computer readable hardware storage medium on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on computer readable hardware storage such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes computer readable storage hardware having instructions stored thereon. The instructions, when executed by corresponding computer processor hardware, cause the computer processor hardware (such as one or more co-located or disparately processor devices or hardware) to: utilize a first wireless channel to support wireless connectivity between a first wireless base station and a first mobile communication device; receive a first notification indicating a second wireless channel allocated for use by the first wireless base station, the second wireless channel being a substitute for the first wireless channel; and in response to receiving first notification, transmit a first message from the first wireless base station, the first message indicating allocation of the second wireless channel to the first wireless base station.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of managing allocated channel information to support efficient communication device handoffs. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a network environment implementing multiple wireless base stations providing wireless network access as discussed herein.

FIG. 2 is an example diagram illustrating management of wireless base station neighbor information and corresponding assignment of wireless channels as discussed herein.

FIG. 3 is an example diagram illustrating communication of update notifications in a wireless network to update wireless base station neighbor information as discussed herein.

FIG. 4 is an example diagram illustrating updating of wireless base station neighbor information as discussed herein.

FIG. 5 is an example diagram illustrating implementation of updated wireless base station neighbor information to support handoffs as discussed herein.

FIG. 6 is an example diagram illustrating communication of update notifications in a wireless network to update wireless base station neighbor information as discussed herein.

FIG. 7 is an example diagram illustrating updating of wireless base station neighbor information as discussed herein.

FIG. 8 is an example diagram illustrating implementation of updated wireless base station neighbor information to support handoffs as discussed herein.

FIG. 9 is an example diagram illustrating example computer hardware and software operable to execute operations as discussed herein.

FIG. 10 is an example diagram illustrating a method as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

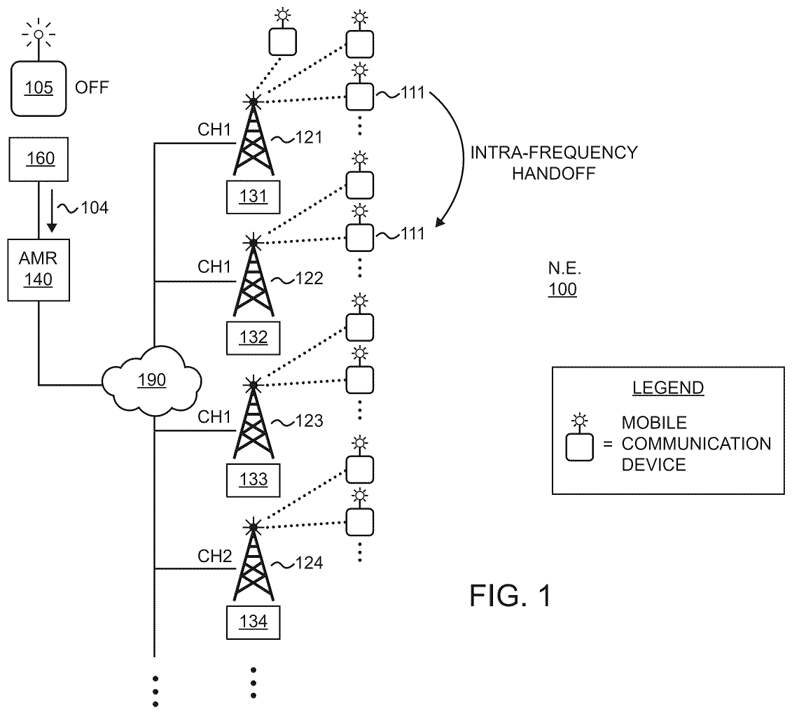

Now, more specifically, with reference to the drawings, FIG. 1 is an example diagram illustrating a network environment implementing multiple wireless base stations providing wireless network access as discussed herein.

As shown in FIG. 1, the network environment 100 includes monitor resource 160 (such as environmental sensing capability), allocation management resource 140 such as a spectrum access system, network 190, multiple wireless base stations (such as wireless base station 121, wireless base station 122, wireless base station 123, wireless base station 124, etc.), and multiple mobile communication devices such as including mobile communication device 111.

Note that each of the resources as discussed herein can be configured as hardware, software, or a combination of hardware and software. For example, the monitor resource 160 can be implemented as monitor hardware, monitor software, or a combination of monitor hardware and monitor software; the allocation management resource 140 can be implemented as allocation management hardware, allocation management software, or a combination of allocation management hardware and allocation management software; wireless base station 121 can be implemented as corresponding communication management hardware, communication management software, or a combination of communication management hardware and communication management software; wireless base station 122 can be implemented as corresponding communication management hardware, communication management software, or a combination of communication manager hardware and communication management software; wireless base station 123 can be implemented as corresponding communication management hardware, communication management software, or a combination of communication management hardware and communication management software; wireless base station 124 can be implemented as corresponding communication management hardware, communication management software, or a combination of communication manager hardware and communication management software; communication device 111 can be implemented as communication hardware, communication software, or a combination of communication hardware and communication software; and so on

In one example, the network 100 and corresponding wireless base stations as discussed herein support wireless connectivity with respective communication devices based on wireless channels allocated from available wireless bandwidth. The wireless channels can be allocated from any suitable band. In one example, each of the wireless base station supports 5G wireless communications (or any other suitable protocol of communications) the use of a respective allocated CBRS (Citizen Band Radio System) channels.

For example, the monitor resource 160 can be configured to monitor use of wireless channels by a respective incumbent entity 105. If the monitor resource 160 detects use of wireless channels by the incumbent entity 105, the monitor resource 160 provides notification to the allocation management resource 140.

As its name suggests, the allocation management resource 140 allocates one or more wireless channels for use by the wireless base stations and corresponding communication devices.

More specifically, the allocation management resource 140 is configured to receive input 104 from the monitor resource 160 indicating whether or not any of wireless channels are being used by a respective incumbent entity 105. In this example, assume that no incumbent entity 105 currently uses wireless channel #1 and wireless channel #2. In such an instance, the allocation management resource 140 or other suitable entity such as a domain proxy allocates use of wireless channel #1 to the wireless base station 121; the allocation management resource 140 or other suitable entity such as a domain proxy allocates use of wireless channel #1 to the wireless base nation 122; the allocation management resource 140 or other suitable entity such as a domain proxy allocates use of wireless channel #1 to the wireless base station 123; the allocation management resource 140 or other suitable entity such as a domain proxy allocates wireless channel #2 to the wireless station 124; and so on.

Thus, the channel allocation management resource 140 can be configured to allocate any of the channels such as channel #1 (CH1), channel #2 (CH2), etc., from a respective tiered hierarchy in which an incumbent entity 105 has highest priority rights use of any of the wireless channels such as channel #1 and channel #2; so-called PAL (Priority Access License) users have second highest priority rights in use of any of the wireless channels #1 and #2; and so-called GAA users have lowest priority rights to use the channels #1 and #2.

As further shown in this example, each of the wireless base stations and corresponding communication management resources is configured to keep track of corresponding one or more wireless channels supported by each nearby wireless base station. The nearness of the wireless base stations to each other or simply whether the wireless base stations are sufficiently near each other can be determined in any suitable manner.

In this example, it is noted that the wireless base stations including wireless base station 121, wireless base station 122, wireless base station 123, wireless base station 124, etc., reside nearby each other and support a same geographical region of wireless coverage. In such an instance, a communication device in the network environment 100 is able to hand off a respective communication link from one wireless base station to another.

More specifically, wireless base station 121 (such as a communication management resource) produces the neighbor information 131 to keep track of the wireless channels supported by each of the nearby wireless base stations 122, 123, 124, etc., in the network environment 100.

Wireless base station 122 (such as a communication management resource) produces the neighbor information 132 to keep track of the wireless channels supported by each of the wireless space stations 121, 123, 124, etc., in the network environment 100.

Wireless base station 123 (such as communication management resource) produces the neighbor information 133 to keep track of the wireless channels supported by each of the wireless base stations 121, 122, 124, etc., in the network environment 100.

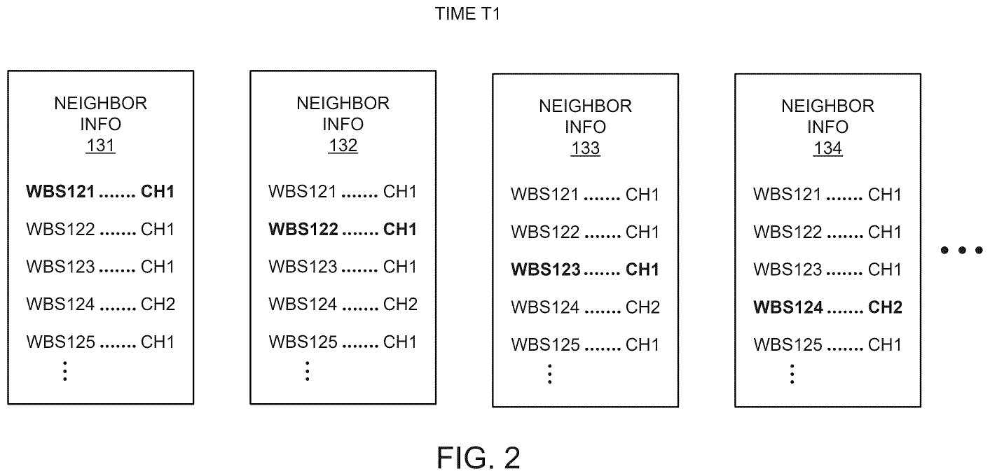

FIG. 2 is an example diagram illustrating management of wireless base station neighbor information as discussed herein.

As previously discussed, the allocation management resource 140 allocates use of one or more wireless channels by each of the wireless base stations. Allocation of wireless channels to the wireless base stations may include the allocation management resource 140 communicating a respective notification over the network 190 to a respective wireless base station.

More specifically, the allocation management resource 140 notifies the wireless base station 121 of the allocation of wireless channel #1 for its use. In response to receiving this notification, the wireless base station 121 provides a respective notification to each of the other wireless base stations such as wireless base station 122, wireless base station 123, wireless base station 124, etc. The respective notification indicates that the wireless base station 121 will be using wireless channel #1 to wirelessly communicate with respective communication devices.

In a similar manner, the allocation management resource 140 notifies the wireless base station 122 of the allocation of wireless channel #1 for its use. In response to receiving this notification, the wireless base station 122 provides a respective notification to each of the other wireless base stations such as wireless base station 121, wireless base station 123, wireless base station 124, etc. The respective notification from the wireless base station 122 indicates that the wireless base station 122 will be using wireless channel #1 to wirelessly communicate with respective communication devices.

In a similar manner, the allocation management resource 140 notifies the wireless base station 123 of the allocation of wireless channel #1 for its use. In response to receiving this notification, the wireless base station 123 provides a respective notification to each of the other wireless base stations such as wireless base station 121, wireless base station 122, wireless base station 124, etc. The respective notification from the wireless base station 123 indicates that the wireless base station 123 will be using wireless channel #1 to wirelessly communicate with respective communication devices.

In a similar manner, the allocation management resource 140 notifies the wireless base station 124 of the allocation of wireless channel #2 for its use. In response to receiving this notification, the wireless base station 124 provides a respective notification to each of the other wireless base stations such as wireless base station 121, wireless base station 122, wireless base station 123, etc. The respective notification from the wireless base station 124 indicates that the wireless base station 124 will be using wireless channel #2 to wirelessly communicate with respective communication devices.

Based on the notification of allocated wireless channels, whether the notifications are received from the allocation management resource 140 directly or from a respective wireless base station, each of the wireless base stations produces respective neighbor information indicating current channel assignment/allocation.

For example, the generated neighbor information 131 associated with and managed by the wireless base station 121 indicates that: the wireless base station 121 has been allocated wireless channel #1; wireless base station 122 has been allocated use of wireless channel #1; wireless base station 123 has been allocated use of wireless channel #1; wireless base station 124 has been allocated use of wireless channel #2; and so on.

The generated neighbor information 132 associated with and managed by the wireless base station 122 indicates that: the wireless base station 121 has been allocated wireless channel #1; wireless base station 122 has been allocated use of wireless channel #1; wireless base station 123 has been allocated use of wireless channel #1; wireless base station 124 has been allocated use of wireless channel #2; and so on.

The generated neighbor information 133 associated with and managed by the wireless base station 123 indicates that: the wireless base station 121 has been allocated wireless channel #1; wireless base station 122 has been allocated use of wireless channel #1; wireless base station 123 has been allocated use of wireless channel #1; wireless base station 124 has been allocated use of wireless channel #2; and so on.

The generated neighbor information 134 associated with and managed by the wireless base station 124 indicates that: the wireless base station 121 has been allocated wireless channel #1; wireless base station 122 has been allocated use of wireless channel #1; wireless base station 123 has been allocated use of wireless channel #1; wireless base station 124 has been allocated use of wireless channel #2; and so on.

Referring again to FIG. 1, it is noted that the neighbor information associated with each of the wireless base stations is useful when performing a respective hand off.

For example, assume that the communication device 111 initially establishes a respective wireless communication link with the wireless base station 121 using the wireless channel #1. Assume further that the wireless base station 121 no longer provides good wireless service to the communication device 111. In such an instance, the communication device 111 or other suitable entity may seek to perform a handoff of the respective wireless communication link from the wireless base station 121 to the wireless base station 122. Via the neighbor information 131 and the neighbor information 132, each of the wireless base station 121 and the wireless a station 122 respectively are already aware that they both support wireless channel #1. In such an instance, the wireless base stations facilitate a respective intra-frequency handoff of the communication device 111 from the wireless base station 121 to the wireless base station 122. In other words, there is no change in channel because the original wireless communication link between the communication device 111 and the wireless base station 121 and final wireless communication link between the communication device 111 and the wireless base station 122 both support wireless channel #1.

As another example, assume that the communication device 111 establishes a respective wireless communication link with the wireless base station 121 using the wireless channel #1. Assume further that the wireless base station 121 no longer provides good wireless service to the communication device 111. In such an instance, the communication device 111 or other suitable entity may seek to perform a handoff of the respective wireless communication link from the wireless base station 121 to the wireless base station 124. Via the neighbor information 131 and the neighbor information 134, each of the wireless base station 121 and the wireless a station 124 are already aware that they support different channels. In such an instance, the wireless base stations facilitate a respective inter-frequency handoff of the communication device 111 from the wireless base station 121 to the wireless base station 124. In other words, if the handoff is implemented, there is a change in channel because the original wireless communication link between the communication device 111 and the wireless base station 121 (wireless channel #1) and final wireless communication link between the communication device 111 and the wireless base station 122 (wireless channel #2) are different.

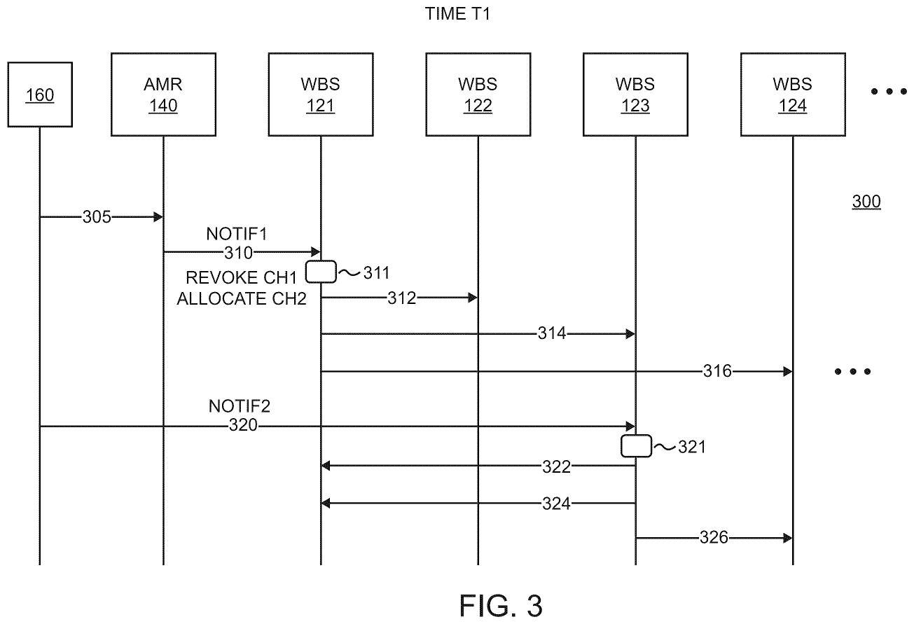

FIG. 3 is an example diagram illustrating communication of update notifications in a wireless network to update wireless base station neighbor information as discussed herein.

As previously discussed, the wireless base station 121 uses a first wireless channel #1 to support wireless connectivity between the wireless base station 121 and the communication device 111. Via communications 305, the allocation management resource 140 receives notification from the monitored resource 160 that the incumbent entity 105 has started to use of or plans to use wireless channel #1. As previously discussed, because the incumbent entity 105 has highest priority use, the allocation management resource 140 determines one or more wireless base stations that may interfere with the incumbent entity 105 if they continued using wireless channel #1.

In this example, assume that the allocation management resource 140 determines that wireless base station 121 and wireless base station 123 are no longer able to use the wireless channel #1 because of detected or intended use of wireless channel #1 by the incumbent entity 105. The allocation management resource 140 determines to revoke use of wireless channel #1 by the wireless base station 121 and the wireless base station 123 so that they do not interfere with the incumbent entity 105 using wireless channel #1.

In such an instance, in response to the decision to revoke use of the wireless channel #1, the allocation management resource 140 transmits communications 310 (such as a first notification) to the wireless base station 121. The communications 310 notify the wireless base station 121 that wireless channel #1 has been revoked and that wireless channel #2 has been assigned as a substitute wireless channel to the wireless base station 121. In such an instance, the wireless base station 121 receives a first notification indicating a second wireless channel #2 newly allocated for use by the wireless base station 121 is an alternative to wireless channel #1, which is being revoked. Note that the wireless channel #2 is a substitute to the revoked first wireless channel #1. Thus, the wireless base station 121 receives notification of the channel change in response to use of the first wireless channel #1 by an incumbent entity 105 having higher priority rights to use the first wireless channel than the first wireless base station 121.

In response to receiving the communications 310, via operation 311, the wireless base station 121 updates its neighbor information 131 to indicate that it is newly assigned the wireless channel #2 to communicate in the network environment 100.

Further, in response to receiving the communications 310, the wireless base station 121 transmits communications 312 (message information) to the wireless base station 122 because the wireless base station 121 knows that the wireless base station 122 is a nearby neighbor. Because the wireless base station 122 is a nearby neighbor to the wireless base station 121, it is known that the second wireless base station 122 is within wireless range of the communication device 111.

The communications 312 from the wireless base station 121 or other suitable entity to the wireless base station 122 notify the wireless base station 122 that the wireless base station 121 has been assigned the wireless channel #2 as a substitute to the wireless channel #1. In response to receiving the communications 312, the wireless base station 122 updates its neighbor information 132 to indicate that the wireless base station 121 is now assigned use of wireless channel #2 instead of wireless channel #1.

In response to receiving the communications 310, the wireless base station 121 also transmits communications 314 to the wireless base station 123. The communications 314 from the wireless base station 121 or other suitable entity to the wireless base station 123 notify the wireless base station 123 that the wireless base station 121 has been assigned the wireless channel #2 as a substitute to the wireless channel #1. In response to receiving the communications 314, the wireless base station 123 updates its neighbor information 133 to indicate that the wireless base station 121 is now assigned use of wireless channel #2 instead of wireless channel #1.

In response to receiving the communications 310, the wireless base station 121 also transmits communications 316 to the wireless base station 124. The communications 316 from the wireless base station 121 or other suitable entity to the wireless base station 124 notify the wireless base station 124 that the wireless base station 121 has been assigned the wireless channel #2 as a substitute to the wireless channel #1. In response to receiving the communications 316, the wireless base station 124 updates its neighbor information 134 to indicate that the wireless base station 121 is now assigned use of wireless channel #2 instead of wireless channel #1.

In a similar manner, the wireless base station 121 provides notification of the newly assigned wireless channel #2 to any wireless base stations in the network environment 100.

Further in this example, the allocation management resource 140 decides to revoke use of the wireless channel #1 by the wireless base station 123 because use of wireless channel #1 by the wireless base station 123 causes interference to the incumbent entity 105.

In such an instance, in response to the decision to revoke use of the wireless channel #1, the allocation management resource 140 transmits communications 320 (such as a second notification) to the wireless base station 123. The communications 320 notify the wireless base station 123 that wireless channel #1 has been revoked and that wireless channel #2 has been assigned as a substitute wireless channel to the wireless base station 123. In such an instance, the wireless base station 123 receives a second notification indicating a second wireless channel #2 allocated for use by the wireless base station 123. Note that the wireless channel #2 is a substitute to the revoked first wireless channel #1. Thus, the wireless base station 123 receives notification in response to use of the first wireless channel #1 by an incumbent entity 105 having higher priority rights to use the first wireless channel than the first wireless base station 123.

In response to receiving the communications 320, via operation 321, the wireless base station 123 updates its neighbor information 133 to indicate that it is newly assigned the wireless channel #2 to communicate in the network environment 100.

Further, in response to receiving the communications 320, the wireless base station 123 transmits communications 322 (message information) to the wireless base station 121 because the wireless base station 123 knows that the wireless base station 121 is a nearby neighbor. Because the wireless base station 121 is a nearby neighbor to the wireless base station 123, it is known that the wireless base station 121 is within wireless range of the communication device 111 as well.

The communications 322 from the wireless base station 123 or other suitable entity to the wireless base station 121 notify the wireless base station 121 that the wireless base station 123 has been assigned the wireless channel #2 as a substitute to the wireless channel #1. In response to receiving the communications 322, the wireless base station 121 updates its neighbor information 131 to indicate that the wireless base station 123 is now assigned use of wireless channel #2 instead of wireless channel #1.

Further, in response to receiving the communications 320, the wireless base station 123 also transmits communications 324 to the wireless base station 122. The communications 324 from the wireless base station 123 or other suitable entity to the wireless base station 122 notify the wireless base station 122 that the wireless base station 123 has been assigned the wireless channel #2 as a substitute to the wireless channel #1. In response to receiving the communications 324, the wireless base station 122 updates its neighbor information 132 to indicate that the wireless base station 123 is now assigned use of wireless channel #2 instead of wireless channel #1.

In response to receiving the communications 320, the wireless base station 123 also transmits communications 326 to the wireless base station 124. The communications 326 from the wireless base station 123 or other suitable entity to the wireless base station 124 notify the wireless base station 124 that the wireless base station 123 has been assigned the wireless channel #2 as a substitute to the wireless channel #1. In response to receiving the communications 326, the wireless base station 124 updates its neighbor information 134 to indicate that the wireless base station 123 is now assigned use of wireless channel #2 instead of wireless channel #1.

In a similar manner, the wireless base station 123 provides notification of the its newly assigned wireless channel #2 to any wireless base stations and the network environment 100. Accordingly, each of the wireless base stations is made aware of newly assigned channel information based on use of wireless channel #1 by the incumbent entity 105.

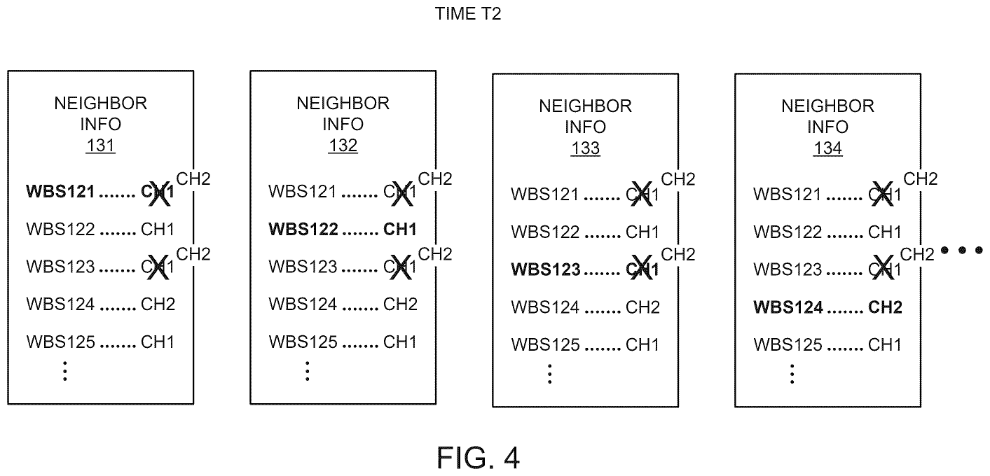

FIG. 4 is an example diagram illustrating updating of wireless base station neighbor information as discussed herein.

As previously discussed, in response to receiving communications 310, the wireless base station 121 updates the neighbor information 131 to indicate that the newly assigned wireless channel #2 is a substitute to the revoked wireless channel #1. Additionally, in response to the wireless base station 121 receiving the communications 322 from the wireless base station 123, the wireless base station 121 updates the neighbor information 131 to indicate that the wireless base station 121 has been newly assigned wireless channel #2 as a substitute to wireless channel #1.

In response to receiving communications 312, the wireless base station 122 updates the neighbor information 132 to indicate the newly assigned wireless channel #2 has been assigned to the wireless base station 121 as a substitute to the wireless channel #1. Additionally, in response to the wireless base station 122 receiving the communications 324 from the wireless base station 123, the wireless base station 122 updates the neighbor information 132 to indicate that the wireless base station 123 has been newly assigned wireless channel #2 as a substitute to wireless channel #1.

In response to receiving communications 320, the wireless base station 123 updates the neighbor information 133 to indicate the newly assigned wireless channel #2 as a substitute to the revoked wireless channel #1. Additionally, in response to the wireless base station 123 receiving the communications 314 from the wireless base station 121, the wireless base station 123 updates the neighbor information 133 to indicate that the wireless base station 121 has been newly assigned wireless channel #2 as a substitute to revoked wireless channel #1.

In response to receiving communications 316, the wireless base station 124 updates the neighbor information 134 to indicate the newly assigned wireless channel #2 has been assigned to the wireless base station 121 as a substitute to the revoked wireless channel #1. Additionally, in response to the wireless base station 124 receiving the communications 326 from the wireless base station 123, the wireless base station 121 updates the neighbor information 134 to indicate that the wireless base station 123 has been newly assigned wireless channel #2 as a substitute to revoked wireless channel #1.

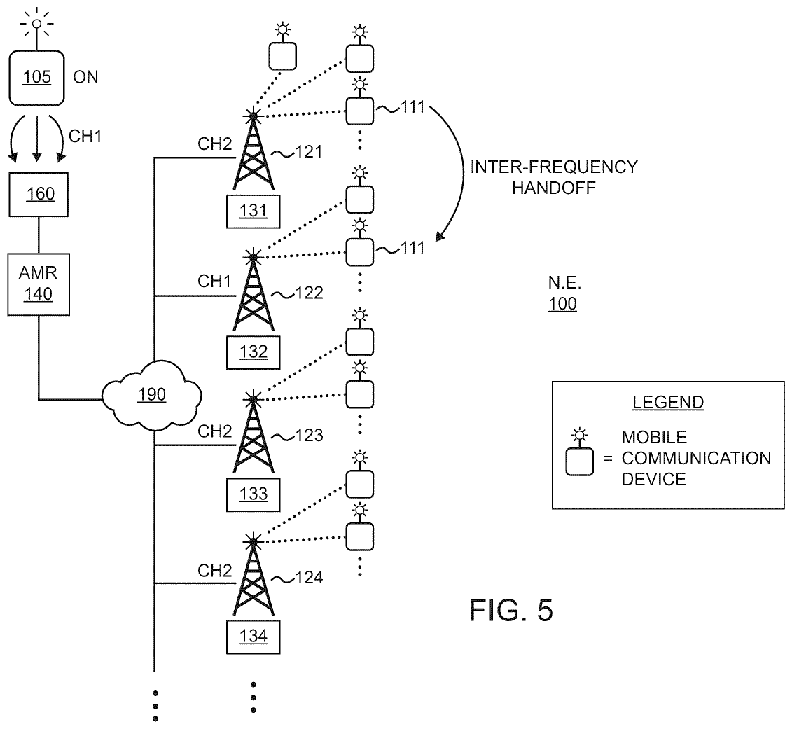

FIG. 5 is an example diagram illustrating implementation of updated wireless base station neighbor information to support intra-frequency handoffs as discussed herein.

In this example, assume that the communication device 111 initially establishes a respective wireless communication link with the wireless base station 121 using the wireless channel #2. Assume further that the wireless base station 121 no longer provides good wireless service to the communication device 111. In such an instance, the communication device 111 or other suitable entity may seek to perform a handoff of the respective wireless communication link from the wireless base station 121 to the wireless base station 122. Via the neighbor information 131 and the neighbor information 132, each of the wireless base station 121 and the wireless base station 122 are already aware that they support different channels. In such an instance, the wireless base stations facilitate a respective inter-frequency handoff of the communication device 111 from the wireless base station 121 to the wireless base station 122. In other words, during the handoff of the communication device 111 from the wireless base station 121 to the wireless base station 122, there is a change in channel (from channel #2 to channel #1) because the channel #2 used in the original wireless communication link between the communication device 111 and the wireless base station 121 (wireless channel #2) and the channel #1 used in the final wireless communication link between the communication device 111 and the wireless base station 122 (wireless channel #1) are different.

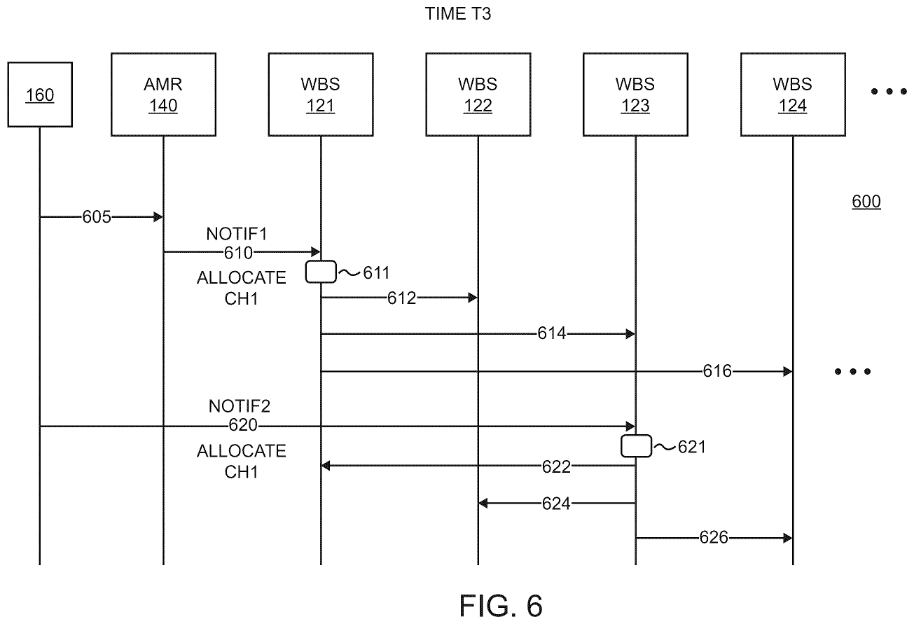

FIG. 6 is an example diagram illustrating communication of update notifications in a wireless network to update wireless base station neighbor information as discussed herein.

Via communications 605, the allocation management resource 140 receives notification from the monitored resource 160 that the incumbent entity 105 has discontinued using wireless channel #1. This means that wireless channel #1 is now free for use by the wireless base stations again.

In such an instance, in response to the decision to reinstate use of the wireless channel #1, the allocation management resource 140 transmits communications 610 (such as a notification) to the wireless base station 121. The communications 610 notify the wireless base station 121 that wireless channel #1 has been reinstated (reassigned) for use by the wireless base station 121 as a substitute to the revoked wireless channel #2.

In response to receiving the communications 610, via operation 611, the wireless base station 121 updates its neighbor information 131 to indicate that it is newly assigned the wireless channel #1 to communicate in the network environment 100.

Further, in response to receiving the communications 610, the wireless base station 121 transmits communications 612 (message information) to the wireless base station 122 because the wireless base station 121 knows that the wireless base station 122 is a nearby neighbor. The communications 612 from the wireless base station 121 or other suitable entity to the wireless base station 122 notify the wireless base station 122 that the wireless base station 121 has been assigned the wireless channel #1 as a substitute to the wireless channel #2. In response to receiving the communications 612, the wireless base station 122 updates its neighbor information 132 to indicate that the wireless base station 121 is now assigned use of wireless channel #1 instead of wireless channel #2.

In response to receiving the communications 610, the wireless base station 121 also transmits communications 614 to the wireless base station 123. The communications 614 from the wireless base station 121 or other suitable entity to the wireless base station 123 notify the wireless base station 123 that the wireless base station 121 has been assigned the wireless channel #1 as a substitute to the wireless channel #2. In response to receiving the communications 614, the wireless base station 123 updates its neighbor information 133 to indicate that the wireless base station 121 is now assigned use of wireless channel #1 instead of wireless channel #2.

In response to receiving the communications 610, the wireless base station 121 also transmits communications 616 to the wireless base station 124. The communications 616 from the wireless base station 121 or other suitable entity to the wireless base station 124 notify the wireless base station 124 that the wireless base station 121 has been assigned the wireless channel #1 is a substitute to be wireless channel #2. In response to receiving the communications 616, the wireless base station 124 updates its neighbor information 134 to indicate that the wireless base station 121 is now assigned use of wireless channel #1 instead of wireless channel #2.

In a similar manner, the wireless base station 121 provides notification of the newly assigned wireless channel #1 to any wireless base stations in the network environment 100.

Further in this example, the allocation management resource 140 decides to reinstate use of the wireless channel #1 by the wireless base station 123 because use of wireless channel #1 by the wireless base station 123 no longer causes interference to the incumbent entity 105.

In such an instance, in response to the decision to reinstate use of the wireless channel #1, the allocation management resource 140 transmits communications 620 (such as a notification) to the wireless base station 123. The communications 620 notify the wireless base station 123 that wireless channel #2 has been revoked and that wireless channel #1 has been assigned as a substitute wireless channel to the wireless base station 123. In such an instance, the wireless base station 123 receives a notification indicating the wireless channel #1 allocated for use by the wireless base station 123.

In response to receiving the communications 620, via operation 321, the wireless base station 123 updates its neighbor information 133 to indicate that it is newly assigned the wireless channel #1 to communicate in the network environment 100.

Further, in response to receiving the communications 620, the wireless base station 123 transmits communications 622 (message information) to the wireless base station 121 because the wireless base station 123 knows that the wireless base station 121 is a nearby neighbor.

The communications 622 from the wireless base station 123 or other suitable entity to the wireless base station 121 notify the wireless base station 121 that the wireless base station 123 has been assigned the wireless channel #1 as a substitute to the wireless channel #2. In response to receiving the communications 622, the wireless base station 121 updates its neighbor information 131 to indicate that the wireless base station 123 is now assigned use of wireless channel #1 instead of wireless channel #2.

Further, in response to receiving the communications 620, the wireless base station 123 also transmits communications 624 to the wireless base station 122. The communications 624 from the wireless base station 123 or other suitable entity to the wireless base station 122 notify the wireless base station 122 that the wireless base station 123 has been assigned the wireless channel #1 as a substitute to the wireless channel #2. In response to receiving the communications 624, the wireless base station 122 updates its neighbor information 132 to indicate that the wireless base station 123 is now assigned use of wireless channel #1 instead of wireless channel #2.

In response to receiving the communications 620, the wireless base station 123 also transmits communications 626 to the wireless base station 124. The communications 626 from the wireless base station 123 or other suitable entity to the wireless base station 124 notify the wireless base station 124 that the wireless base station 123 has been assigned the wireless channel #1 as a substitute to the wireless channel #2. In response to receiving the communications 626, the wireless base station 124 updates its neighbor information 134 to indicate that the wireless base station 123 is now assigned use of wireless channel #1 instead of wireless channel #2.

In a similar manner, the wireless base station 123 provides notification of the its newly assigned wireless channel #1 and revocation of wireless channel #2 to any wireless base stations and the network environment 100.

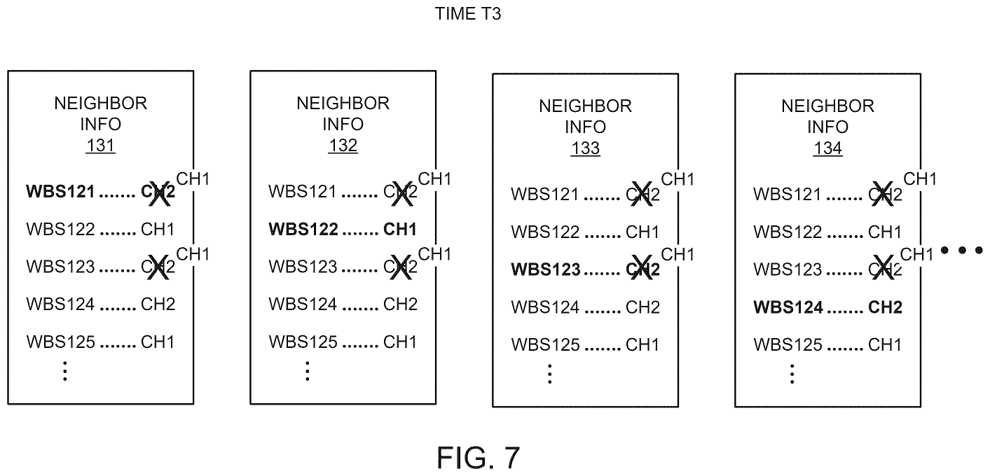

FIG. 7 is an example diagram illustrating updating of wireless base station neighbor information as discussed herein.

As shown, each of the wireless base stations updates their respective neighbor information to indicate the different allocated wireless channels associated with each sufficiently nearby wireless base station in the network environment.

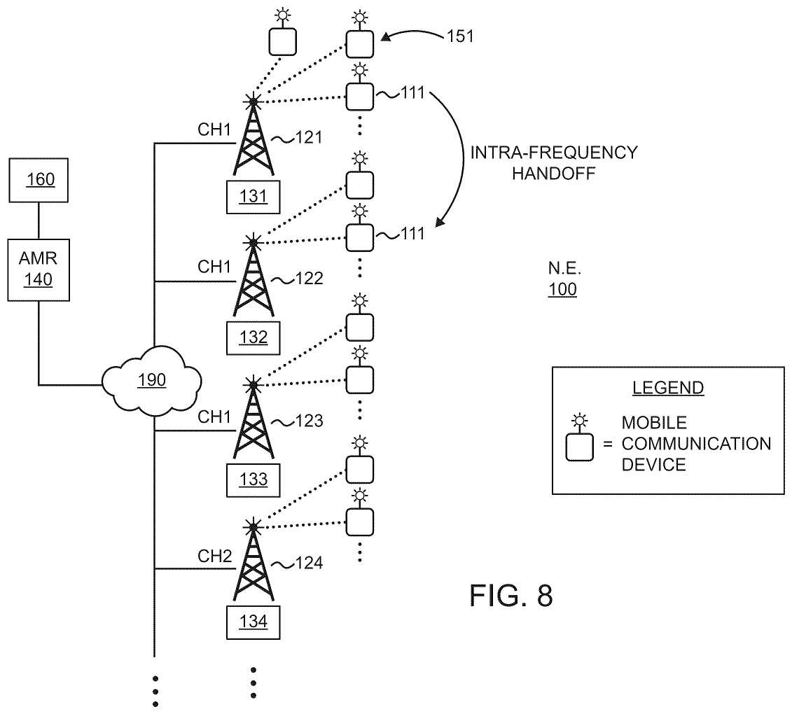

FIG. 8 is an example diagram illustrating implementation of updated wireless base station neighbor information to support intra-frequency handoffs as discussed herein.

In this example, assume that the communication device 111 initially establishes a respective wireless communication link with the wireless base station 121 using the wireless channel #1. Assume further that the wireless base station 121 no longer provides good wireless service to the communication device 111. In such an instance, the communication device 111 or other suitable entity may initiate a handoff of the respective wireless communication link from the wireless base station 121 to the wireless base station 122. Via the neighbor information 131 and the neighbor information 132, each of the wireless base station 121 and the wireless base station 122 are already aware that they support the same channel #1. In such an instance, the wireless base stations facilitate a respective intra-frequency handoff of the communication device 111 from the wireless base station 121 to the wireless base station 122. In other words, during the handoff of the communication device 111 from the wireless base station 121 to the wireless base station 122, there is no change in channel (from channel #1 to channel #1) because the original wireless communication link between the communication device 111 and the wireless base station 121 (wireless channel #1) and final wireless communication link between the communication device 111 and the wireless base station 122 (wireless channel #1) are the same.

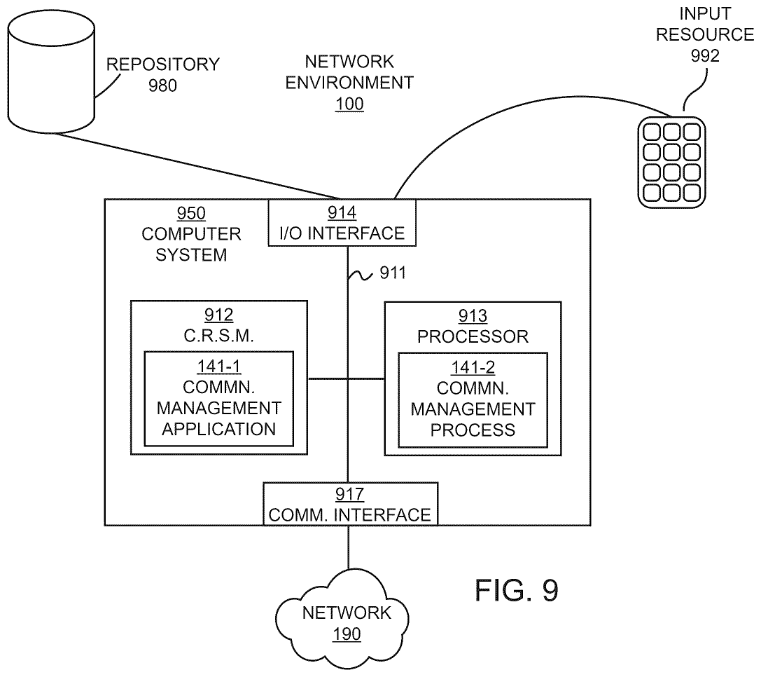

FIG. 9 is an example block diagram of a computer system for implementing any of the operations as previously discussed according to examples herein.

Note that any of the resources (such as allocation management resource 140, wireless base station 121, wireless base station 122, wireless station 123, wireless base station 124, communication device 111, any communication management resource associated with a respective wireless base station, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 such as a non-transitory type of media or computer readable storage hardware (which can be any suitable type of resource in which digital information can be stored and or retrieved), a processor 913 (computer processor hardware), I/O interface 914, and a communications interface 917.

I/O interface(s) 914 supports connectivity to repository 980 and input resource 992.

Computer readable storage medium 912 can be any computer readable storage hardware or hardware storage device such as memory, optical storage, hard drive, floppy disk, etc. In one example, the computer readable storage medium 912 stores instructions and/or data.

As shown, computer readable storage media 912 can be encoded with communication management application 141-1 in a respective one or more network nodes to carry out any of the operations as discussed herein.

During operation of one example, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different examples, note that computer system executing any of the operations as discussed herein may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

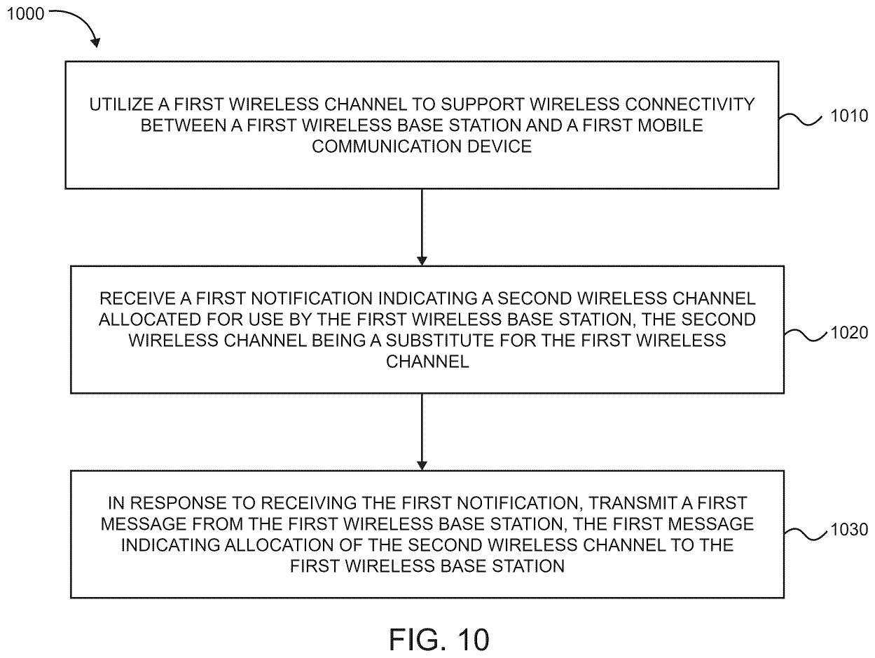

Functionality supported by the different resources will now be discussed via flowchart 1000 in FIG. 10. Note that the steps in the flowcharts below can be executed in any suitable order.

FIG. 10 is a flowchart 1000 illustrating an example method according to examples herein. Note that there will be some overlap with respect to concepts as discussed above.

In processing operation 1010, the wireless base station 121 (such as communication management resource) utilizes a first wireless channel to support wireless connectivity between the wireless base station 121 and the communication device 111.

In processing operation 1020, the wireless base station 121 receives communications indicating a second wireless channel #2 allocated for use by the wireless base station 121. The second wireless channel #2 is a substitute to the previously allocated first wireless channel #1.

In processing operation 1030, in response to receiving the communications indicating the newly assigned wireless channel #2 is a substitute to the first wireless channel #1, the wireless base station 121 transmits communications from the first wireless base station 121 to the wireless base station 122. As previously discussed, the communications indicate allocation of the second wireless channel #2 to the wireless base station 121.

Note again that techniques herein are well suited to facilitate management and use of wireless channels in the network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this example has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

We claim:

1. A method comprising:
utilizing a first wireless channel to support wireless connectivity between a first wireless base station and a first mobile communication device;
receiving a first notification indicating a second wireless channel allocated for use by the first wireless base station, the second wireless channel being a substitute for the first wireless channel; and
in response to receiving the first notification, transmitting a first message from the first wireless base station, the first message indicating allocation of the second wireless channel to the first wireless base station.

2. The method as in claim 1 further comprising:
receiving the first notification in response to use of the first wireless channel by an entity having higher priority rights to use the first wireless channel than the first wireless base station.

3. The method as in claim 1, wherein transmitting the first message from the first wireless base station includes:
transmitting the first message from the first wireless base station to a second wireless base station, the second wireless base station being in wireless range of the first mobile communication device.

4. The method as in claim 1 further comprising:
transmitting the first message from the first wireless base station to a second wireless base station in response to detecting a condition in which the second wireless base station supports receiving handoffs from the first wireless base station.

5. The method as in claim 1, wherein a second wireless base station receiving the first message from the first wireless base station is assigned use of the first wireless channel to support wireless connectivity with mobile communication devices.

6. The method as in claim 1 further comprising:
receiving a second notification indicating the first wireless channel allocated for use by the first wireless base station instead of the second wireless channel; and
in response to receiving the second notification, transmitting a second message from the first wireless base station, the second message indicating allocation of the first wireless channel to the first wireless base station again.

7. The method as in claim 6 further comprising:
receiving the second notification in response to discontinued use of the first wireless channel by an entity having higher priority rights to use the first wireless channel than the first wireless base station.

8. The method as in claim 1 further comprising:
at the first wireless base station, receiving a second message from a second wireless base station, the second message indicating allocation of the second wireless channel to the second wireless base station.

9. The method as in claim 8 further comprising:
in response to receiving the second message, updating neighbor information indicating associated with the first wireless base station, the updated neighbor information indicating that the second wireless base station supports the second wireless channel for handoffs between the first wireless base station and the second wireless base station.

10. The method as in claim 1 further comprising:
at a second wireless station, updating respective neighbor information indicating that the first wireless base station supports the second wireless channel instead of the first wireless channel for handoffs between the first wireless base station and the second wireless base station.

11. A system comprising:
communication management hardware operative to:
utilize a first wireless channel to support wireless connectivity between a first wireless base station and a first mobile communication device;
receive a first notification indicating a second wireless channel allocated for use by the first wireless base station, the second wireless channel being a substitute for the first wireless channel; and
in response to receiving the first notification, transmit a first message from the first wireless base station, the first message indicating allocation of the second wireless channel to the first wireless base station.

12. The system as in claim 11, wherein the communication management hardware is further operative to:
receive the first notification in response to use of the first wireless channel by an entity having higher priority rights to use the first wireless channel than the first wireless base station.

13. The system as in claim 11, wherein the communication management hardware is further operative to:
transmit the first message from the first wireless base station to a second wireless base station, the second wireless base station being in wireless range of the first mobile communication device.

14. The system as in claim 11, wherein the communication management hardware is further operative to:
transmit the first message from the first wireless base station to a second wireless base station in response to detecting a condition in which the second wireless base station supports receiving handoffs from the first wireless base station.

15. The system as in claim 11, wherein a second wireless base station receiving the first message from the first wireless base station is assigned use of the first wireless channel to support wireless connectivity with mobile communication devices.

16. The system as in claim 11, wherein the communication management hardware is further operative to:
receive a second notification indicating the first wireless channel allocated for use by the first wireless base station instead of the second wireless channel; and
in response to receiving the second notification, transmitting a second message from the first wireless base station, the second message indicating allocation of the first wireless channel to the first wireless base station again.

17. The system as in claim 16, wherein the communication management hardware is further operative to:
receive the second notification in response to discontinued use of the first wireless channel by an entity having higher priority rights to use the first wireless channel than the first wireless base station.

18. The system as in claim 11, wherein the communication management hardware is further operative to:
at the first wireless base station, receive a second message from a second wireless base station, the second message indicating allocation of the second wireless channel to the second wireless base station.

19. The system as in claim 18, wherein the communication management hardware is further operative to:
in response to receiving the second message, update neighbor information associated with the first wireless base station, the updated neighbor information indicating that the second wireless base station supports the second wireless channel for handoffs between the first wireless base station and the second wireless base station.

20. The system as in claim 11 further comprising:
a second wireless station operative to update respective neighbor information indicating that the first wireless base station supports the second wireless channel instead of the first wireless channel for handoffs between the first wireless base station and the second wireless base station.

21. Computer-readable storage hardware having instructions stored thereon, the instructions, when carried out by computer processor hardware, cause the computer processor hardware to:
utilize a first wireless channel to support wireless connectivity between a first wireless base station and a first mobile communication device;
receive a first notification indicating a second wireless channel allocated for use by the first wireless base station, the second wireless channel being a substitute for the first wireless channel; and
in response to receiving the first notification, transmit a first message from the first wireless base station, the first message indicating allocation of the second wireless channel to the first wireless base station.
